(19) United States
(12) Patent Application Publication
(10) Pub. No.: US 2008/0291152 A1
(43) Pub. Date: Nov. 27, 2008

(54) LIQUID CRYSTAL DISPLAY APPARATUS AND DISPLAY METHOD

(76) Inventors: Kenji NAKAO, Kanazawa-shi (JP); Yukio Tanaka, Kanazawa-shi (JP); Shigesumi Araki, Kanazawa-shi (JP); Kazuhiro Nishiyama, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/123,053

(22) Filed: May 19, 2008

(30) Foreign Application Priority Data
May 21, 2007 (JP) 2007-134525

(51) Int. Cl. G02F 1/13357; G09G 3/36

(52) U.S. Cl. 345/102; 349/68

(57) ABSTRACT

A liquid crystal display apparatus includes a display panel in which liquid crystal pixels, which are composed with use of an OCB mode liquid crystal, are arranged in a matrix, first and second backlights which illuminate the display panel, and driving control means for controlling the display panel, wherein light from the first backlight is emitted with an inclination of a predetermined angle in a first direction to a plane which is perpendicular to a display surface of the display panel and extends along an alignment direction of liquid crystal molecules, and light from the second backlight is emitted with an inclination of the predetermined angle to the plane, the first direction and the second direction being symmetric to each other with regard to the plane.

### CROSS-REFERENCE TO RELATED APPLICATIONS

This application is based upon and claims the benefit of priority from prior Japanese Patent Application No. 2007-134525, filed May 21, 2007, the entire contents of which are incorporated herein by reference.

### BACKGROUND OF THE INVENTION

1. Field of the Invention

The present invention relates to a liquid crystal display apparatus which is capable of performing stereoscopic display or two-directional video display.

2. Description of the Related Art

Liquid crystal display apparatuses have widely been used as display apparatuses of personal computers, information portable terminals, televisions or car navigation systems by taking advantage of their features such as light weight, small thickness and low power consumption.

The liquid crystal display apparatus normally displays single two-dimensional information. However, there has been proposed a liquid crystal display apparatus which can also perform stereoscopic display or can perform different screen displays at the same time on the same screen. For instance, there have been proposed a two-screen display apparatus for vehicle use, which displays video that appears differently when viewed from a driver seat and a front passenger seat, and a 3-D display apparatus which performs stereoscopic display by displaying video for the right eye and video for the left eye.

There is known a parallax barrier method as a technique for enabling such display (Jpn. Pat. Appln. KOKAI Publication No. H5-107663 and Jpn. Pat. Appln. KOKAI Publication No. H10-161061).

FIG. 18 is a conceptual view of the parallax barrier method. A pixel for a right direction and a pixel for a left direction are individually formed on a liquid crystal panel DP. A parallax barrier layer 51 is formed so that one of lights, which are emitted through the respective pixels, can be observed in an oblique direction. A lenticular lens may be provided as the parallax barrier layer 51, thereby to enhance directivity.

In the methods disclosed in Jpn. Pat. Appln. KOKAI Publication No. H5-107663 and Jpn. Pat. Appln. KOKAI Publication No. H10-161061, for example, left and right images are displayed in each vertical pixel line of the liquid crystal panel DP. Thus, the pixels of 1 line of the liquid crystal panel DP is shared by a pixel line for a right image and a pixel line for a left image, and the resolution of each image is low, compared to the number of pixels of the liquid crystal panel DP. In addition, it is necessary to form the parallax barrier layer 51 with high precision.

### BRIEF SUMMARY OF THE INVENTION

According to a first aspect of the present invention, there is provided a liquid crystal display apparatus comprising: a display panel in which liquid crystal pixels, which are composed with use of an OCB mode liquid crystal, are arranged in a matrix; first and second backlights which illuminate the display panel; and driving control means for controlling the display panel, wherein light from the first backlight is emitted with an inclination of a predetermined angle in a first direction to a plane which is perpendicular to a display surface of the display panel and extends along an alignment direction of liquid crystal molecules, and light from the second backlight is emitted with an inclination of the predetermined angle to the plane, the first direction and the second direction being symmetric to each other with regard to the plane.

According to a second aspect of the present invention, there is provided a liquid crystal display method of a liquid crystal display apparatus comprising a display panel in which liquid crystal pixels, which are composed with use of an OCB mode liquid crystal, are arranged in a matrix, first and second backlights which illuminate the display panel, and driving control means for controlling the display panel, the method comprising: displaying a first image on the display panel and emitting light from the first backlight with an inclination of a predetermined angle in a first direction to a plane which is perpendicular to a display surface of the display panel and extends along an alignment direction of liquid crystal molecules; and displaying a second image on the display panel and emitting light from the second backlight with an inclination of the predetermined angle to the plane, the first direction and the second direction being symmetric to each other with regard to the plane.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for explaining the outline of the present invention;

FIG. 2 is a view that schematically shows a circuit structure of a liquid crystal display apparatus;

FIG. 3 is a view that schematically shows the structure of a source driver;

FIG. 4 is a view for describing the direction of a liquid crystal panel;

FIG. 5 is a cross-sectional view of a liquid crystal panel which is included in a liquid crystal display apparatus according to an embodiment of the present invention;

FIG. 6 is a cross-sectional view of a liquid crystal panel which is included in a liquid crystal display apparatus according to a variation example;

FIG. 7 is a cross-sectional view showing, in enlarged scale, a liquid crystal portion of the liquid crystal panel;

FIG. 8A is a view for explaining observation angle characteristics of retardation of a liquid crystal layer;

FIG. 8B is a view for explaining observation angle characteristics of retardation of a liquid crystal layer;

FIG. 9A is a view showing an alignment direction of liquid crystal molecules which constitute the liquid crystal panel;

FIG. 9B is a view showing an alignment direction of liquid crystal molecules which constitute the liquid crystal panel;

FIG. 10 is a view showing observation angle characteristics of retardation of a retardation film;

FIG. 11 is a view for explaining a method of canceling retardation of liquid crystal molecules of the liquid crystal layer;

FIG. 12 is a view that shows the structure of discotic liquid crystal molecules which compensate alignment of a liquid crystal;

FIG. 13 is a table showing specifications of the liquid crystal panel;

FIG. 14 is a graph showing a transmittance distribution (left-and-right direction) of the liquid crystal panel;

FIG. 15 is a view for explaining a driving method of the liquid crystal display apparatus according to the embodiment;

FIG. 16 is a view that shows a display which displays different video images when viewed from a driver seat and a front passenger seat;

FIG. 17 is a view illustrating a competition game; and

FIG. 18 is a conceptual view of a parallax barrier method.

### DETAILED DESCRIPTION OF THE INVENTION

### First Embodiment

In an embodiment to be described below, stereoscopic display is described by way of example, but the invention is not limited to this example.

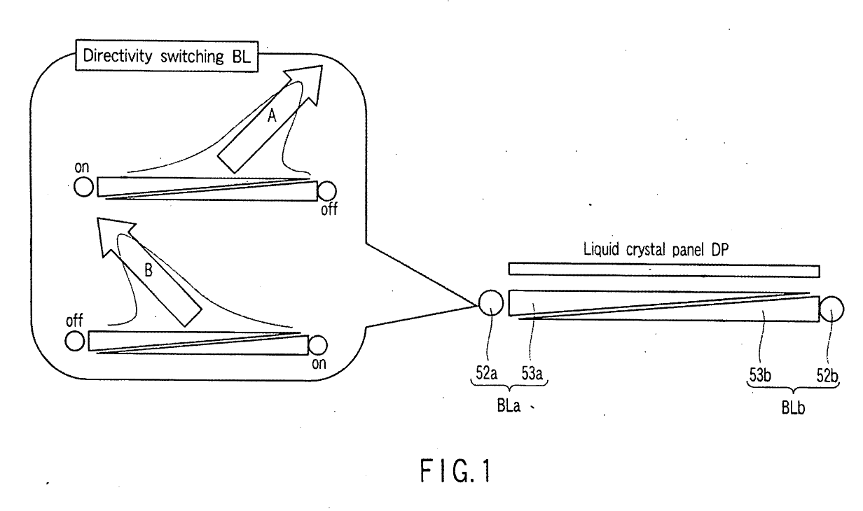

FIG. 1 is a view for explaining the outline of the present invention.

In a liquid crystal display apparatus relating to the present invention, a backlight BL is provided under a transmissive liquid crystal panel DP. The backlight BL is composed of a backlight BLa which includes a light source 52a and a backlight guide plate 53a, and a backlight BLb which includes a light source 52b and a backlight guide plate 53b. When the light source 52a is turned on, light is emitted in a right direction (in the Figure) by the backlight guide plate 53a. When the light source 52b is turned on, light is emitted in a left direction (in the Figure) by the backlight guide plate 53b.

When stereoscopic display is performed, the light source 52a is turned on during a time period in which a right image (an image for the left eye of an observer) is displayed on the liquid crystal panel DP, and the light source is switched and the light source 52b is turned on during a time period in which a left image (an image for the right eye of the observer) is displayed on the liquid crystal panel DP. The left and right parallax images are successively displayed on the liquid crystal panel DP in this time division manner, and the directivity of the light source for illumination is switched in sync with this. Thereby, these parallax images can be led to the left and right eyes of the observer.

FIG. 1 schematically shows the structure of the liquid crystal display apparatus. In an actual display apparatus, optical elements for adjusting the directivity of light, such as a collimate lens and a prism film, may be provided, as needed, between the liquid crystal panel DP and the backlight BL.

In the meantime, in order to display different video images by time-dividing one frame period, it is an indispensable condition to use a liquid crystal with a high response speed. Thus, in the present embodiment, use is made of an OCB mode (Optically Compensated Bend) liquid crystal which has a high liquid crystal responsivity that is needed for displaying a moving image, and can realize a wide viewing angle.

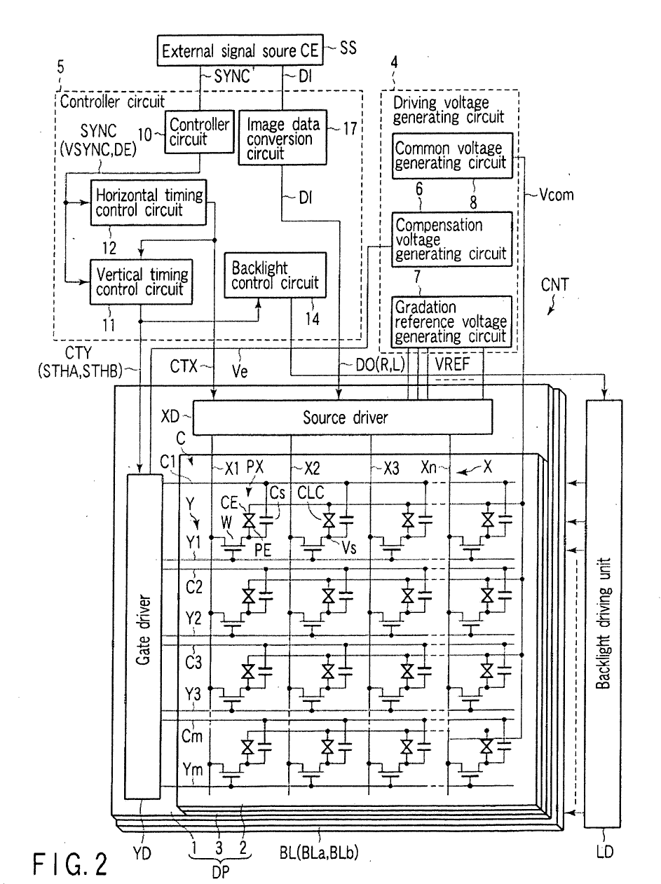

FIG. 2 is a view that schematically shows a circuit structure of a liquid crystal display apparatus.

The liquid crystal display device includes a liquid crystal panel DP, a backlight BL (BLa, BLb) which illuminates the liquid crystal panel DP, and a display control circuit CNT which controls the liquid crystal panel DP and the backlight BL.

The liquid crystal panel DP is configured such that a liquid crystal layer 3 is held between a pair of substrates, namely, an array substrate 1 and a counter-substrate 2. The liquid crystal layer 3 includes, as a liquid crystal material, a liquid crystal which is transitioned in advance from splay alignment to bend alignment, for example, in order to perform a normally-white display operation, and which is prevented from being reversely transitioned from the bend alignment to the splay alignment by a voltage that is applied.

The display control circuit CNT controls the transmittance of the liquid crystal panel DP by a liquid crystal driving voltage that is applied to the liquid crystal layer 3 from the array substrate 1 and counter-substrate 2. The transition from the splay alignment to the bend alignment is carried out by applying a relatively high electric field to the liquid crystal in a predetermined initializing process which is performed by the display control circuit CNT at the time of power-on.

In the array substrate 1, a plurality of pixel electrodes PE are arranged substantially in a matrix on a transparent insulating substrate GL. A plurality of gate lines Y (Y1 to Ym) are disposed along rows of the plural pixel electrodes PE, and a plurality of source lines X (X1 to Xn) are disposed along columns of the plural pixel electrodes PE.

A plurality of pixel switching elements W are disposed near intersections between the gate lines Y and source lines X. Each of the pixel switching elements W is composed of, e.g. a thin-film transistor which has a gate connected to the gate line Y, and a source-drain path connected between the source line X and pixel electrode PE. When the pixel switching element W is driven via the associated gate line Y, the switching element W is rendered conductive between the associated source line X and associated pixel electrode PE.

Each pixel electrode PE and a common electrode CE are formed of a transparent electrode material such as ITO, are covered with alignment films AL, respectively, and constitute a liquid crystal pixel PX together with a pixel region which is a part of the liquid crystal layer 3 that is controlled to have a liquid crystal molecular alignment corresponding to an electric field from the pixel electrode PE and common-electrode CE.

Each of the liquid crystal pixels PX has a liquid crystal capacitance CLC between the pixel electrode PE and common-electrode CE. Each of a plurality of storage capacitance lines C1 to Cm is capacitive-coupled to the pixel electrodes PE of the liquid crystal pixels PX of the associated row, and constitutes storage capacitances Cs. The storage capacitance Cs has a sufficiently high capacitance value, relative to a parasitic capacitance of the pixel switching element W.

The display control circuit CNT includes a gate driver YD, a source driver XD, a backlight driving unit LD, a driving voltage generating circuit 4 and a controller circuit 5.

The gate driver YD successively drives the gate lines Y1 to Ym so as to turn on the switching elements W on a row-by-row basis. The source driver XD outputs pixel voltages Vs to the source lines X1 to Xn during the period in which the switching elements W of each row are turned on by the driving of the associated gate line Y. The backlight driving unit LD drives the backlight BL. The driving voltage generating circuit 4 generates driving voltages for the liquid crystal panel DP. The controller circuit 5 controls the gate driver YD, source driver XD and backlight driving unit LD.

The driving voltage generating circuit 4 may include capacitive-coupling driving which includes a compensation voltage generating circuit 6 which generates a compensation voltage Ve that is applied to the storage capacitance line C. In addition, the driving voltage generating circuit 4 includes a gradation reference voltage generating circuit 7 which generates a predetermined number of gradation reference voltages VREF that are used by the source driver XD, and a common voltage generating circuit 8 which generates a common voltage Vcom that is applied to the counter-electrode CT.

The controller circuit 5 includes a control circuit 10, a vertical timing control circuit 11, a horizontal timing control circuit 12, an image data conversion circuit 17 and a backlight control circuit 14.

The control circuit 10 generates new sync signals SYNC (VSYNC, DE) on the basis of a sync signal SYNC′ which is input from an external signal source SS, and generates a signal which controls the operations of the respective parts of the display control circuit CNT.

The vertical timing control circuit 11 generates a control signal CTY for the gate driver YD on the basis of the sync signals SYNC (VSYNC, DE) that are input from the control circuit 10. The horizontal timing control circuit 12 generates a control signal CTX for the source driver XD on the basis of the sync signals SYNC (VSYNC, DE) that are input from the control circuit 10.

The image data conversion circuit 17 temporarily stores image data DI (left image data, right image data) which is input from the external signal source SS in association with the plural pixels PX, and outputs the image data DI to the source driver XD at a predetermined timing. The backlight control circuit 14 controls the backlight driving unit LD on the basis of the control signal CTY that is output from the vertical timing control circuit 11.

The image data DI comprises a plurality of image data corresponding to the plural liquid crystal pixels PX, and is updated twice in one frame period (vertical scanning period V) with respect to the left image data and right image data. The control signal CTY is supplied to the gate driver YD, and the control signal CTX, together with pixel data DO that is obtained from the image data conversion circuit 17, is supplied to the source driver XD. The control signal CTY is used in order to cause the gate driver YD to execute the operation of successively driving the plural gate lines Y, as described above. The control signal CTX is used in order to cause the source driver XD to execute the operation of allocating to the plural source lines X the pixel data DO that is obtained from the image data conversion circuit 17 in units of a pixel and is serially output, and the operation of designating the output polarity.

The gate driver YD is composed by using, for example, a shift register in order to select the gate lines Y. Two kinds of gate pulses, which are associated with the left image data and right image data, are output.

The display operation of the left image data and right image data in the present embodiment will be described later in detail.

The source driver XD refers to the predetermined number of gradation reference voltages VREF which are supplied from the gradation reference voltage generating circuit 7, converts the pixel data DO to pixel voltages Vs, and outputs the pixel voltages Vs to the source lines X1 to Xn in a parallel fashion.

The pixel voltage Vs is a voltage that is applied to the pixel electrode PE, with the common voltage Vcom of the common electrode CE being used as a reference, and the polarity of the pixel voltage Vs is reversed relative to the common voltage Vcom, for example, so as to execute frame-inversion driving or line-inversion driving. In a case where reflective-part display driving is executed at double the vertical scan speed, the polarity is reversed relative to the common voltage Vcom so as to execute, e.g. line-inversion driving (1H inversion driving) and frame-inversion driving.

The compensation voltage Ve is applied via the gate driver YD to the storage capacitance line C corresponding to the gate line Y that is connected to the switching elements W when the switching elements W of one row are rendered non-conductive, and such capacitive-coupling driving may be execute that the variation of the pixel voltages Vs occurring in the pixels PX of one row is compensated by the parasitic capacitances of these switching elements W.

If the gate driver YD drives, e.g. the gate line Y1 by an ON voltage and turns on all pixel switching elements W connected to this gate line Y1, the pixel voltages Vs on the source lines X1 to Xn are supplied to the associated pixel electrodes PE and one-side end portions of the storage capacitances Cs via the pixel switching elements W.

In addition, the gate driver YD outputs the compensation voltage Ve from the compensation voltage generating circuit 6 to the storage capacitance line C1 that corresponds to the gate line Y1, turns on all pixel switching elements W, which are connected to the gate line Y, only during one horizontal scanning period, and outputs, immediately thereafter, an OFF voltage for turning off these pixel switching elements W, to the gate line Y1. When these pixel switching elements W are turned off, the compensation voltage Ve reduces the amount of charge that is to be extracted from the pixel electrodes PE due to the parasitic capacitances of the pixel switching elements W, thereby substantially canceling a variation in pixel voltage Vs, that is, a field-through voltage ΔVp.

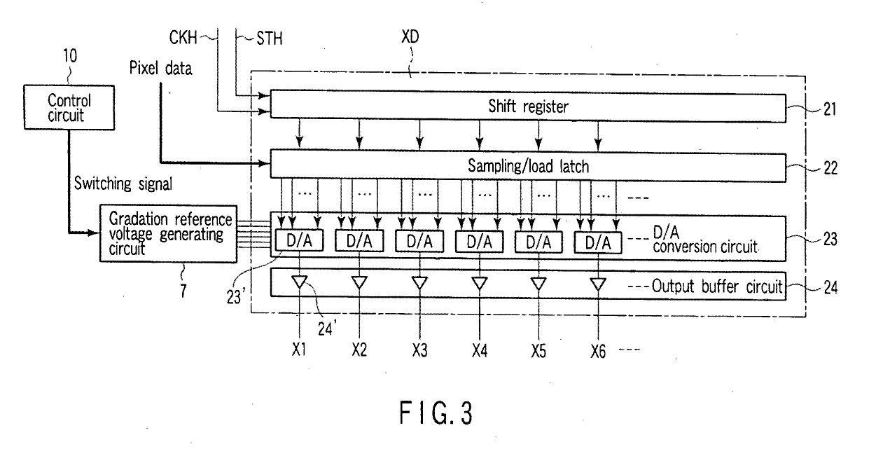

FIG. 3 schematically shows the structure of the source driver XD.

The source driver XD includes a shift register 21, a sampling/load latch 22, a digital/analog (D/A) conversion circuit 23 and an output buffer circuit 24.

The control signal CTX includes a horizontal start signal STH which controls a take-in start timing of pixel data for one row, and a horizontal clock signal CKH for shifting the horizontal start signal STH in the shift register 21.

The shift register 21 shifts the horizontal start signal STH in sync with the horizontal clock signal CKH, and controls the timing of successively serial/parallel converting the pixel data DO. The sampling/load latch 22 successively latches the pixel data DO for the pixels PX of one row by the control of the shift register 21, and outputs the image data DO in parallel. The digital/analog conversion circuit 23 converts the pixel data DO to analog-format pixel voltages. The output buffer circuit 24 outputs the analog pixel voltages, which are obtained from the D/A conversion circuit 23, to the source lines X1, . . . , Xn. The D/A conversion circuit 23 is configured to refer to the plural gradation reference voltages VREF which are generated from the gradation reference voltage generating circuit 7. The gradation reference voltage generating circuit 7 outputs the gradation reference voltages VREF by executing switching between the gradation reference voltages VREF for the left image data and the gradation reference voltages VREF for the right image data in one frame period in accordance with a switching signal from the control circuit 10.

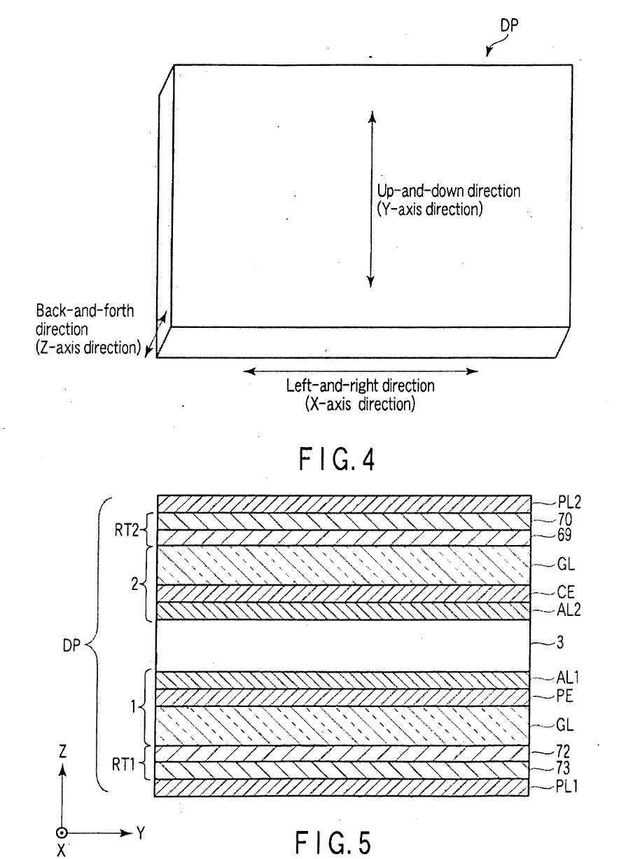

Next, the structure of the liquid crystal panel DP is described. In the description below, as shown in FIG. 4, the left-and-right direction of the liquid crystal panel DP is referred to as “X-axis direction”, the up-and-down direction as “Y-axis direction”, and the back-and-forth direction as “Z-axis direction”.

FIG. 5 is a cross-sectional view of the liquid crystal panel which is included in the liquid crystal display apparatus according to the embodiment of the present invention.

As shown in FIG. 5, in the liquid crystal panel DP, two substrates, namely, a counter-substrate 2 and an array substrate 1 are disposed to be opposed. A liquid crystal layer 3 is formed between the counter-substrate 2 and the array substrate 1.

The counter-substrate 2 is configured such that a common electrode CE and an alignment film AL2 are successively stacked on a back surface of a transparent insulating substrate GL. The array substrate 1 is configured such that a pixel electrode PE and an alignment film AL1 are successively stacked on a front surface of a transparent insulating substrate GL.

A retardation film RT2 is provided on a front surface of the counter-substrate 2. The retardation film RT2 is configured such that a retardation film 70 having negative uniaxiality is stacked on a front surface of a hybrid-aligned discotic film 69.

A retardation film RT1 is provided on a back surface of the array substrate 1. The retardation film RT1 is configured such that a hybrid-aligned discotic film 72 and a retardation film 73 having negative uniaxiality are successively stacked.

Further, a polarizer PL2 is provided on a front surface of the retardation film RT2, and a polarizer PL1 is provided on a back surface of the retardation film RT1.

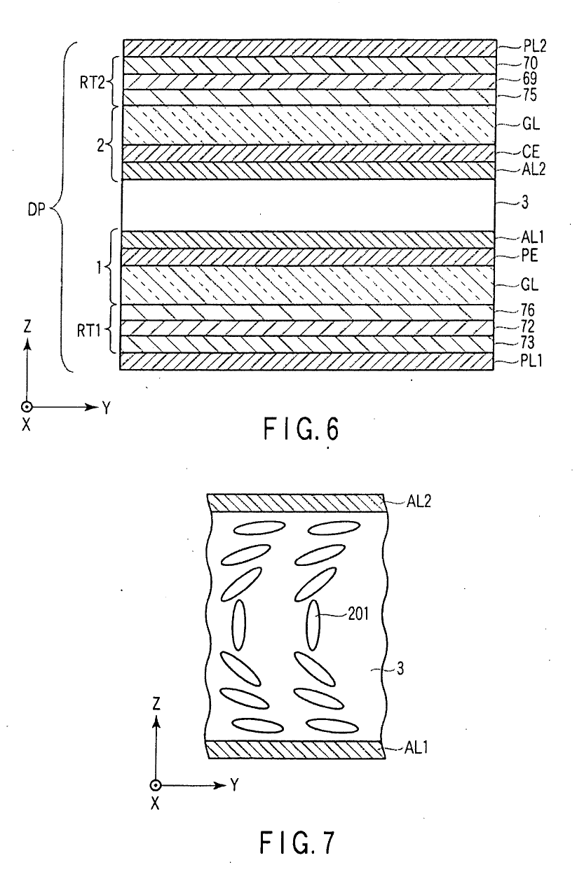

Such a structure may be adopted that a retardation film having positive uniaxiality is added to the discotic film 69 and the negative uniaxial film 70. Specifically, as shown in FIG. 6, a positive uniaxial film 75 may be stacked on a front surface of the negative uniaxial film 70, and thereby the retardation film RT2 may be composed of the discotic film 69, negative uniaxial film 70 and positive uniaxial film 75.

In addition, a positive uniaxial film 76 may be added to the discotic film 72 and the negative uniaxial film 73.

Next, the optical characteristics of the liquid crystal panel DP having the above-described structure are explained.

A retardation Re in an in-plane direction and a retardation Rth in a thickness direction of a retardation film, which are characteristic values of the retardation film, are given by the following equations (1) and (2):

Re=(nx−ny)×d equation (1)

Rth=((nx+ny)/2−nz)×d equation (2)

where nx and ny are refractive indices in the in-plane direction of the retardation film, nz is a refractive index in the thickness direction of the retardation film, and d is a thickness of the retardation film. The greater one of the refractive indices nx and ny in the in-plane direction of the retardation film is nx.

In the meantime, in the liquid crystal layer 3 and retardation films RT1 and RT2, the retardation thereof varies in accordance with a variation of the observation angle.

FIG. 7 is a cross-sectional view showing, in enlarged scale, a liquid crystal portion of the liquid crystal panel DP.

In the liquid crystal layer 3, for example, liquid crystal molecules 201 are aligned in the up-and-down direction (Y-axis direction) of the liquid crystal panel DP, and these liquid crystal molecules 201 are bend-aligned in a Z-Y plane (hereinafter referred to as “alignment plane”) which is perpendicular to a display surface of the liquid crystal panel DP and extends along the alignment direction of the liquid crystal molecules 201. The OCB liquid crystal is characterized in that the liquid crystal molecules 201, which are present between the alignment films AL1 and AL2, are aligned in a bow shape (“bend alignment”).

If a voltage is applied to the bend-aligned liquid crystal molecules 201, the degree of bending of the bow shape varies and the amount of light passing through the two polarizers, between which the liquid crystal layer is held, is adjusted. Thereby, black and white of video is created. In the bend alignment, the movement of liquid crystal molecules 201, which is similar to bending of a bow, produces an acceleration effect of alignment variation, and a higher response speed than in the prior art can be achieved.

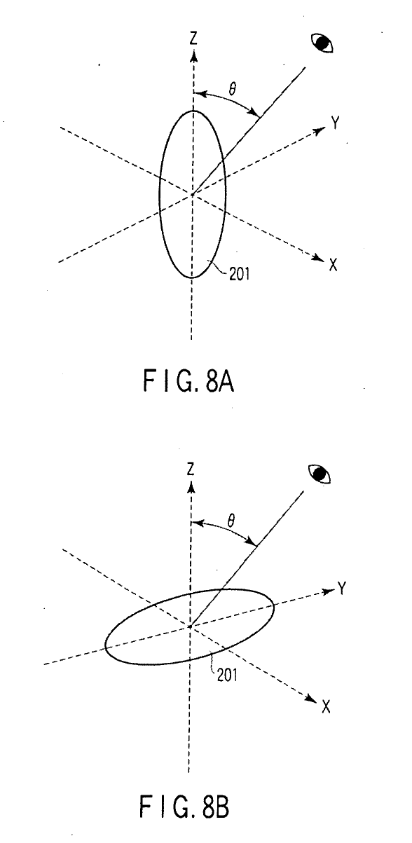

FIG. 8A and FIG. 8B are views for explaining observation angle characteristics of retardation of the liquid crystal layer 3.

The refractive index anisotropy of the liquid crystal molecule 201 occurs due to the anisotropy of its shape. Accordingly, when the liquid crystal molecule 201 is observed, retardation occurs in the liquid crystal molecule 201 in the case where anisotropy is present in the shape of the liquid crystal molecule 201 which is viewed in an observation direction.

FIG. 8A shows a case in which the liquid crystal molecule 201 in a standing state is observed. The liquid crystal molecule 201 has a rod shape, and the center axis of the rod shape agrees with the Z axis. The observer observes the liquid crystal molecule 201 in a direction at an angle θ from the Z axis.

When the observation angle θ is 0°, that is, when the liquid crystal molecule 201 is observed in the Z-axis direction, the liquid crystal molecule 201 appears in a circular shape, and there is no anisotropy in its shape. Accordingly, no retardation occurs in the liquid crystal molecule 201.

Next, in a case where the view point is moved from this initial state toward the X-axis direction by the observation angle θ, the liquid crystal molecule 201 appears in such a shape that the liquid crystal molecule 201 has a major axis in the X-axis direction. Accordingly, in the liquid crystal molecule 201, such retardation occurs that a component in the view point movement direction (X-axis direction) becomes a slow phase.

On the other hand, in a case where the view point is moved from the initial state toward the Y-axis direction by the observation angle θ, the liquid crystal molecule 201 appears in such a shape that the liquid crystal molecule 201 has a major axis in the Y-axis direction. Accordingly, in the liquid crystal molecule 201, such retardation occurs that a component in the view point movement direction (Y-axis direction) becomes a slow phase.

The shape anisotropy of the liquid crystal molecule 201 that is viewed in the observation direction increases in both the X-axis direction and Y-axis direction in accordance with the increase of the observation angle θ. Thus, the retardation of the liquid crystal molecule 201 increases as the observation angle θ becomes larger.

FIG. 8B shows a case in which the liquid crystal molecule 201 in a fallen state is observed. The liquid crystal molecule 201 has a rod shape, and the center axis of the rod shape agrees with the Y axis. The observer observes the liquid crystal molecule 201 in a direction at an angle θ from the Z axis.

In a case where the view point is moved from the state in which the observation angle θ is 0° toward the X-axis direction by the observation angle θ, the liquid crystal molecule 201 appears in such a shape that the liquid crystal molecule 201 has a major axis in the Y-axis direction. Accordingly, in the liquid crystal molecule 201, such retardation occurs that a component in the view point movement direction (Y-axis direction) becomes a slow phase.

The shape of the liquid crystal molecule 201, which is viewed in the observation direction, hardly varies even if the observation angle θ is increased. Thus, the retardation of the liquid crystal molecule 201 hardly varies even if the observation angle θ is increased.

On the other hand, in a case where the view point is moved from the state in which the observation angle θ is 0° toward the Y-axis direction by the observation angle θ, the liquid crystal molecule 201 appears in such a shape that the liquid crystal molecule 201 has a major axis in the Y-axis direction. Accordingly, in the liquid crystal molecule 201, such retardation occurs that a component in the view point movement direction (Y-axis direction) becomes a slow phase.

The shape anisotropy of the liquid crystal molecule 201 that is viewed in the observation direction decreases in accordance with the increase of the observation angle θ. Thus, the retardation of the liquid crystal molecule 201 decreases as the observation angle θ becomes larger.

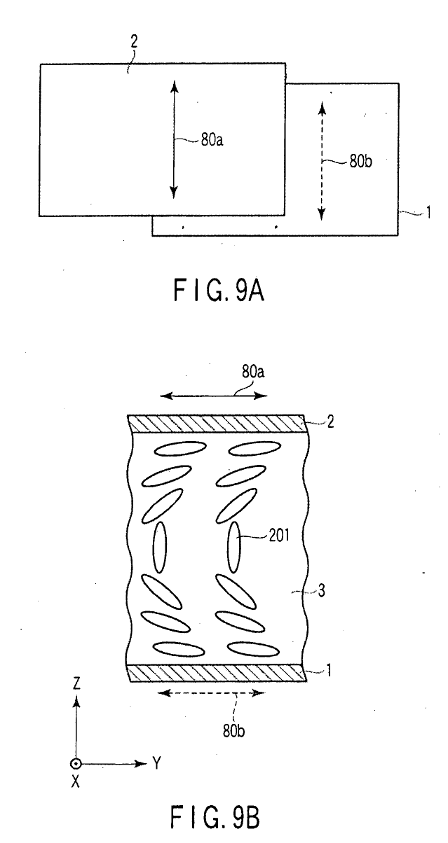

FIG. 9A and FIG. 9B show the alignment direction of liquid crystal molecules which constitute the liquid crystal panel DP.

Arrows 80a and 80b in FIG. 9A indicate rubbing directions of the counter-substrate 2 and array substrate 1, respectively. Specifically, both the counter-substrate 2 and array substrate 1 are subjected to rubbing treatment in the up-and-down direction (Y-axis direction) of the liquid crystal panel DP. Accordingly, as shown in FIG. 9B, the liquid crystal molecules which constitute the liquid crystal panel DP are aligned in the up-and-down direction of the liquid crystal panel DP. The liquid crystal molecules 201 are bend-aligned in an alignment plane, that is, a Y-Z plane which is a plane extending in the alignment direction.

Hence, in the liquid crystal panel DP that is included in the liquid crystal display apparatus according to the present embodiment, lights from the backlights BLa and BLb are symmetrically incident on the liquid crystal molecules 201 at a predetermined angle from both sides of the alignment plane of the liquid crystal molecules 201 that are aligned along the rubbing direction. Specifically, the light from the backlight BLa is emitted with an inclination of a predetermined angle in a first direction to the alignment plane, that is, the plane which is perpendicular to the display surface of the liquid crystal display panel DP and extends along the alignment direction of the liquid crystal molecules. The light from the backlight BLb is emitted with an inclination of the predetermined angle to the alignment plane in a second direction that is symmetric to the first direction. As a result, the value of the retardation of the liquid crystal molecule 201 becomes substantially equal between the left eye position and the right eye position of the observer. Therefore, there occurs no difference in modulation ratio between images which are observed by the left eye and the right eye, and high-quality stereoscopic display can be obtained.

However, in the case where the rubbing direction is not the up-and-down direction, but is, for example, an oblique direction, the light is incident on the liquid crystal molecules 201 at different angles from both sides of the alignment plane of the liquid crystal molecules 201. Then, the value of the retardation of the liquid crystal molecule 201 becomes different between the left eye position and the right eye position of the observer. Consequently, there occurs a difference in modulation ratio between images which are observed by the left eye and the right eye, and stereoscopic display with poor quality is performed.

Next, the observation angle characteristics of retardation of the retardation film RT1, RT2 are explained.

The retardation film RT1, RT2 is composed of a film which is mainly formed of a medium having an optically negative uniaxial anisotropy, for example, discotic liquid crystal molecules, and such a discotic film is composed such that discoidal discotic liquid crystal molecules are stacked in the thickness direction of the film.

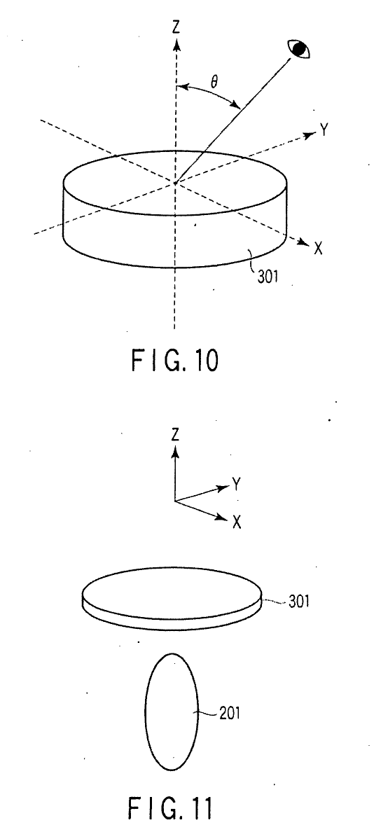

FIG. 10 is a view showing observation angle characteristics of retardation of the retardation film RT1, RT2.

To begin with, consider the state in which the discoidal discotic liquid crystal molecule 301 is positioned in parallel to the X-Y plane, as shown in FIG. 10. There is no anisotropy in the shape of the discotic liquid crystal molecule 301 in the case where the observation angle θ is 0°, that is, in the case where the discotic liquid crystal molecule 301 is viewed in the Z-axis direction. Accordingly, no retardation occurs in the discotic liquid crystal molecule 301.

Next, in a case where the view point is moved from this state toward the X-axis direction by an observation angle θ, the discotic liquid crystal molecule 301 appears in such a shape that the discotic liquid crystal molecule 301 has a major axis in the Y-axis direction. Accordingly, in the discotic liquid crystal molecule 301, such retardation occurs that a component in the Y-axis direction becomes a slow phase.

Similarly, in a case where the view point is moved from the state in which the observation angle θ is 0° toward the Y-axis direction so that the observation angle θ may vary, the discotic liquid crystal molecule 301 appears in such a shape that the discotic liquid crystal molecule 301 has a major axis in the X-axis direction. Accordingly, in the discotic liquid crystal molecule 301, such retardation occurs that a component in the X-axis direction becomes a slow phase.

The shape anisotropy of the discotic liquid crystal molecule 301 that is viewed in the observation direction increases in accordance with the increase of the observation angle θ. Thus, the retardation of the discotic liquid crystal molecule 301 increases as the observation angle θ becomes larger.

In the OCB mode liquid crystal display apparatus, in the liquid crystal layer 3, the liquid crystal molecules are aligned in such a manner as to be continuous in a bow shape. By disposing the discotic liquid crystal molecules 301 in accordance with the bend-aligned liquid crystal layer 3, the viewing angle characteristics can be improved.

Next, this principle is explained successively.

FIG. 11 is a view for explaining a method of canceling retardation of the liquid crystal molecules 201 of the liquid crystal layer 3. FIG. 11 shows a case in which the major axis of the rod-shaped liquid crystal molecule 201 is positioned perpendicular to the discotic liquid crystal molecule 301.

In the case where the observation angle θ is varied toward the X-axis direction, as described above, such retardation occurs in the liquid crystal molecule 201, that a component in the X-axis direction becomes a slow phase. On the other hand, in the discotic liquid crystal molecule 301, such retardation occurs that a component in the Y-axis direction becomes a slow phase. Accordingly, both retardations are canceled.

Similarly, in the case where the observation angle θ is varied toward the Y-axis direction, as described above, such retardation occurs in the liquid crystal molecule 201 that a component in the Y-axis direction becomes a slow phase. On the other hand, in the discotic liquid crystal molecule 301, such retardation occurs that a component in the X-axis direction becomes a slow phase. Accordingly, both retardations are canceled.

It is understood from this that if the discotic liquid crystal molecule 301 is disposed perpendicular to the major axis of the rod-shaped liquid crystal molecule 201, the retardation occurring in the liquid crystal molecule 201 due to the variation of the observation angle θ can be canceled by the retardation occurring in the discotic liquid crystal molecule 301 due to the variation of the observation angle θ.

If consideration is given to the bend alignment of the liquid crystal molecules 201 in the liquid crystal layer 3, as shown in FIG. 7, liquid crystal molecules 201 are in the standing state in the middle region of the liquid crystal layer 3, while liquid crystal molecules 201 are gradually aligned into the fallen state toward the alignment film AL1, AL2. Hereinafter, this alignment is referred to as “hybrid alignment”.

From the above discussion, it is understood that the retardation occurring in the hybrid-aligned liquid crystal molecules 201 can be canceled by disposing each of the plural discotic liquid crystal molecules 301 in a position perpendicular to the major axis of each of the hybrid-aligned liquid crystal molecules 201.

Specifically, if the plural discotic liquid crystal molecules 301 are stacked such that the states of the discotic liquid crystal molecules 301 gradually vary from the states in which the discotic liquid crystal molecules 301 are parallel to the array substrate 1 and counter-substrate 2 to the states in which the discotic liquid crystal molecules 301 are perpendicular to the array substrate 1 and counter-substrate 2, it becomes possible to cancel the retardation occurring in the hybrid-aligned liquid crystal molecules 201.

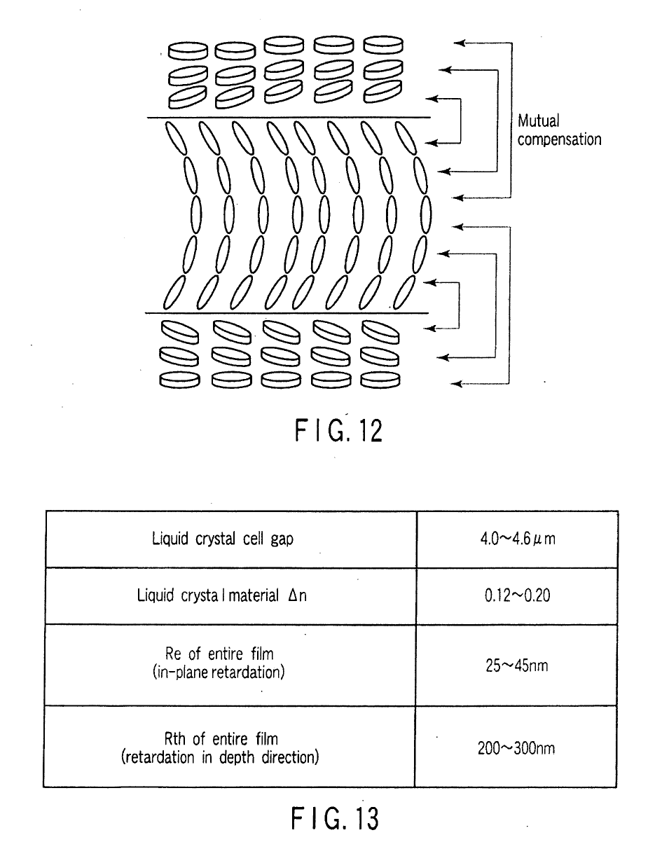

FIG. 12 is a view that shows the structure of discotic liquid crystal molecules which compensate alignment of a liquid crystal.

In this case, the parts, in which discotic liquid crystal molecules 301 are stacked in parallel to the array substrate 1 and counter-substrate 2, correspond to the negative uniaxial films 70 and 73 of the retardation films RT1 and RT2 shown in FIG. 5, and the parts, in which discotic liquid crystal molecules 301 are hybrid-aligned, correspond to the discotic films 69 and 72.

FIG. 13 is a table showing specifications of the liquid crystal panel.

The present invention, however, is not limited to the ranges indicated by numerical values, and proper adjustment may be made. For example, when the cell gap increases by 20%, the specifications may be so altered that the Rth of the film may increase by about 20%.

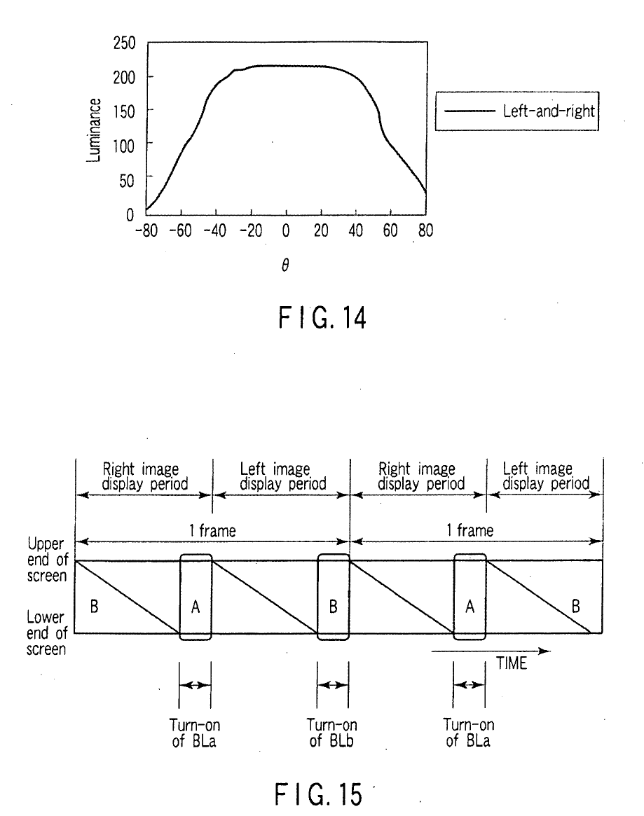

FIG. 14 is a graph showing a transmittance distribution (left-and-right direction) of the liquid crystal panel DP. The ordinate indicates luminance, and the abscissa indicates observation angles.

As shown in this Figure, the transmittance distribution curve is symmetric in the left-and-right direction with respect to a center line corresponding to the observation angle θ of 0° C. This is an advantage that is obtained by setting the rubbing direction at the up-and-down direction perpendicular to the left-and-right direction.

The value of the luminance is substantially constant over the range of observation angles θ between −40° and +40°. This is an advantage that is obtained by using the negative uniaxial films as the retardation films RT1 and RT2.

In this manner, the variation of the retardation of the liquid crystal layer 3 in relation to the observation angle θ is canceled by the variation of the retardation of the retardation films RT1 and RT2 in relation to the observation angle θ. As a result, the liquid crystal panel DP, in which the viewing angle characteristics are substantially unchanged in all directions, was successfully obtained.

Next, a description is given of a driving method of the liquid crystal display apparatus according to the present invention. In this embodiment, a right image display period and a left image display period are provided in one frame period, and pixel voltages for a right image and a left image are supplied to liquid crystal pixels in the respective periods.

FIG. 15 is a view for explaining a driving method of the liquid crystal display apparatus according to the embodiment.

The driving method is described with reference to FIG. 1 to FIG. 3, and FIG. 15. As has been described above, two kinds of gate pulses for right image display and left image display are provided as gate pulses for selecting gate lines Y, which are output from the gate driver YD.

The control signal CTY includes a first start signal (right image display start signal) STHA, a second start signal (left image display start signal) STHB, a clock signal and an output enable signal.

The first start signal (right image display start signal) STHA controls the right image display start timing. The second start signal (left image display start signal) STHB controls the left image display start timing. The clock signal shifts these start signals STHA and STHB in the shift register circuit. The output enable signal controls the output of driving signals to the gate lines Y1 to Ym, which are successively or simultaneously selected in units of a predetermined number by the shift register circuit in accordance with the hold positions of the start signals STHA and STHB.

On the other hand, the control signal CTX includes a start signal, a clock signal, a load signal and a polarity signal.

To begin with, the right image display operation is explained.

The gate driver YD, by the control of the control signal CTY, successively selects the gate lines Y1 to Ym for right image display in a ⅓ period of one frame period, and supplies an ON signal to the selected gate line Y as a driving signal for turning on the pixel switching elements W of each row during only a 1 horizontal scanning period H. The input pixel data DI of one row is converted to right image display pixel data R of one row. The right image display pixel data R of one row is serially output from the image data conversion circuit 17.

The control circuit 10 outputs a switching signal to the gradation reference voltage generating circuit 7 in sync with the timing of the output of the pixel data R from the image data conversion circuit 17. The gradation reference voltage generating circuit 7 switches the gradation reference voltages VREF to those for right image display, and outputs the gradation reference voltages VREF.

The source driver XD refers to the predetermined number of gradation reference voltages VREF which are supplied from the gradation reference voltage generating circuit 7, converts the pixel data R to pixel voltages Vs, and outputs the pixel voltages Vs to the source lines X1 to Xn in a parallel fashion.

The control circuit 10 outputs a turn-on/off signal to the backlight driving circuit 14 at a predetermined timing in accordance with the right image display period. The backlight driving circuit 14 drives the backlight driving unit LD and controls turn-on/off of the backlight BLa.

In FIG. 15, the backlight BLa is turned on in a ⅙ period of one frame period, from the completion of the display of a right image on the display panel to the beginning of display of a left image.

Next, the left image display operation is explained. The gate driver YD, by the control of the control signal CTY, successively selects the gate lines Y1 to Ym for left image display in a ⅓ period of one frame period, and supplies an ON signal to the selected gate line Y as a driving signal for turning on the pixel switching elements W of each row during only the 1 horizontal scanning period H. The input pixel data DI of one row is converted to left image display pixel data L of one row. The left image display pixel data L of one row is serially output from the image data conversion circuit 17.

The control circuit 10 outputs a switching signal to the gradation reference voltage generating circuit 7 in sync with the timing of the output of the pixel data L from the image data conversion circuit 17. The gradation reference voltage generating circuit 7 switches the gradation reference voltages VREF to those for left image display, and outputs the gradation reference voltages VREF.

The source driver XD refers to the predetermined number of gradation reference voltages VREF which are supplied from the gradation reference voltage generating circuit 7, converts the pixel data L to pixel voltages Vs, and outputs the pixel voltages Vs to the source lines X1 to Xn in a parallel fashion.

The control circuit 10 outputs a turn-on/off signal to the backlight driving circuit 14 at a predetermined timing in accordance with the left image display period. The backlight driving circuit 14 drives the backlight driving unit LD and controls turn-on/off of the backlight BLb.

In FIG. 15, the backlight BLb is turned on in a ⅙ period of one frame period, from the completion of the display of a left image on the display panel to the beginning of display of a right image.

The above description has been given of the example in which the liquid crystal display apparatus of the present invention is used as a stereoscopic display apparatus in which images for the right eye and the left eye are alternately switched. However, the present invention is not limited to this embodiment.

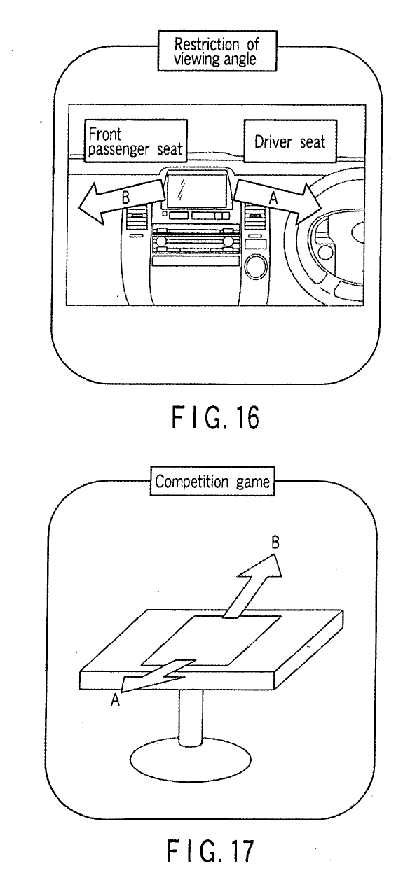

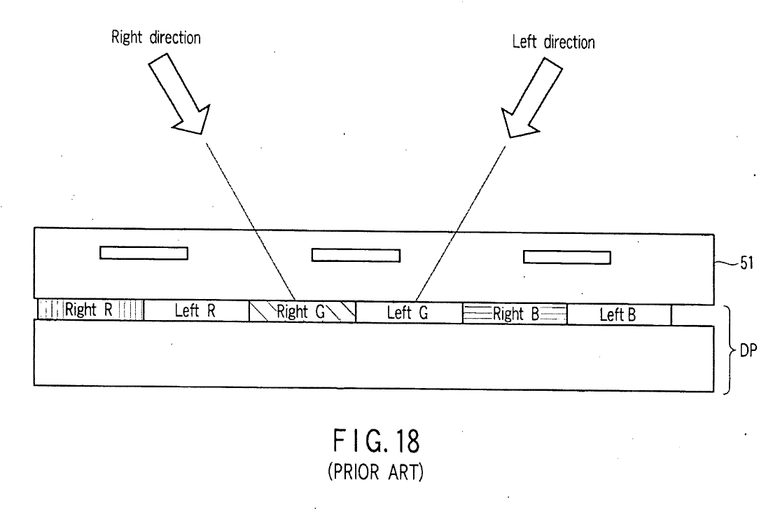

The present invention relates to a liquid crystal display which can display two-directional images. As shown in FIG. 16, the invention is applicable to a display for a vehicle, in which images to be displayed are varied between a driver seat and a front passenger seat. Besides, as shown in FIG. 17, the invention is applicable to competition games for business-purpose game machines, portable game machines, etc.

According to the present invention, if an image A and an image B are made identical, normal display can be performed without degrading display quality. In this case, backlights A and B may be kept in the ON state. It is also possible to display identical images A and B in usual cases, and to perform 3D display or two-directional display only in special situations.

In general, in liquid crystal display devices, an “alternating current mode” is adopted to alternately switch the polarity for display in every write operation, thereby preventing accumulation of DC electric field. In the case of the present invention, driving at 120 Hz is effectively executed, but an alternating current mode with 60 Hz may be adopted. The reason is as follows. In a case where a screen A and a screen B are heterogeneous, a DC may possibly remain in sync with display. Thus, in order to enable the alternating current mode in both the screen A and screen B, the alternating current mode with 60 Hz is adopted.

Needless to say, the present display apparatus is not limited to 60 Hz. Driving at 150 Hz driving may be executed with an input waveform of 75 Hz. In this case, flickering may advantageously be further reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus comprising:
a display panel in which liquid crystal pixels, which are composed with use of an OCB mode liquid crystal, are arranged in a matrix;
first and second backlights which illuminate the display panel; and
driving control means for controlling the display panel,
wherein light from the first backlight is emitted with an inclination of a predetermined angle in a first direction to a plane which is perpendicular to a display surface of the display panel and extends along an alignment direction of liquid crystal molecules, and
light from the second backlight is emitted with an inclination of the predetermined angle to the plane, the first direction and the second direction being symmetric to each other with regard to the plane.

2. The liquid crystal display apparatus according to claim 1, wherein the driving control means executes control to display first and second images in one frame period.

3. The liquid crystal display apparatus according to claim 2, wherein the driving control means executes control to turn on the first backlight in a period in which display of the first image is controlled, and executes control to turn on the second backlight in a period in which display of the second image is controlled.

4. The liquid crystal display apparatus according to claim 2, wherein a direction of rubbing treatment for aligning the OCB mode liquid crystal is parallel between a front surface and a back surface of the display panel.

5. The liquid crystal display apparatus according to claim 4, wherein the display panel includes a retardation film which imparts a negative retardation to light.

6. The liquid crystal display apparatus according to claim 5, wherein the first and second images are observed in different directions.

7. The liquid crystal display apparatus according to claim 6, wherein the first and second images are parallax images, and
the liquid crystal display apparatus has a stereoscopic display function.

8. A liquid crystal display method of a liquid crystal display apparatus comprising a display panel in which liquid crystal pixels, which are composed with use of an OCB mode liquid crystal, are arranged in a matrix, first and second backlights which illuminate the display panel, and driving control means for controlling the display panel, the method comprising:
displaying a first image on the display panel and emitting light from the first backlight with an inclination of a predetermined angle in a first direction to a plane which is perpendicular to a display surface of the display panel and extends along an alignment direction of liquid crystal molecules; and
displaying a second image on the display panel and emitting light from the second backlight with an inclination of the predetermined angle to the plane, the first direction and the second direction being symmetric to each other with regard to the plane.

9. The liquid crystal display method according to claim 8, wherein the first image is an image for the right eye, and the second image is an image for the left eye.

10. The liquid crystal display method according to claim 8, wherein the first backlight is turned on after completion of the first image, and the second backlight is turned on after completion of the second image.

11. The liquid crystal display method according to claim 10, wherein the first backlight is turned off prior to display of the second image.
